(19) United States
(12) Patent Application Publication
(10) Pub. No.: US 2010/0020292 A1
(43) Pub. Date: Jan. 28, 2010

(54) PORTABLE TRANSMISSIVE TYPE PROJECTOR

(75) Inventor: YUAN-HSU CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/463,428

(22) Filed: May 11, 2009

(30) Foreign Application Priority Data
Jul. 28, 2008 (CN) 200810303130.7

(51) Int. Cl. G03B 21/20

(52) U.S. Cl. 353/38; 353/119

(57) ABSTRACT

An exemplary portable transmissive type projector includes a light source module configured for emitting light beams, a projection lens module, and a transmission type liquid crystal panel. The liquid crystal panel is disposed between the light source module and the projection lens module and configured for displaying images. The projection lens module is configured for projecting the displayed images illuminated by the light beams onto an external object for viewing.

### BACKGROUND

1. Technical Field

The present disclosure relates to projectors, and particularly, to a transmissive type projector that can be carried or moved easily.

2. Discussion of Related Art

Projectors are widely used for, e.g., conference room presentations, classroom training, home theatre, and live events applications.

Typically, a projector has a bulb, a reflector, at least one of condensing lens, and a holder for accommodating these elements. However, all these elements require a significant amount of space, which can make the projector unduly bulky.

Therefore, what is needed is a projector to overcome the above-described deficiencies.

### BRIEF DESCRIPTION OF THE DRAWINGS

Many aspects of various exemplary embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is an isometric view of a portable projector in accordance with an exemplary embodiment.

FIG. 2 is an exploded view of the portable projector of FIG. 1.

### DETAILED DESCRIPTION

Reference will now be made to the drawings to describe in detail various embodiments of the present portable projector.

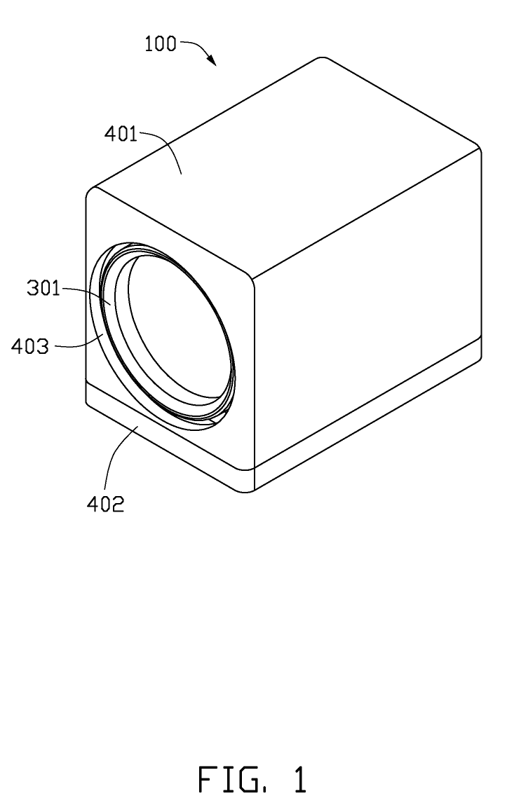

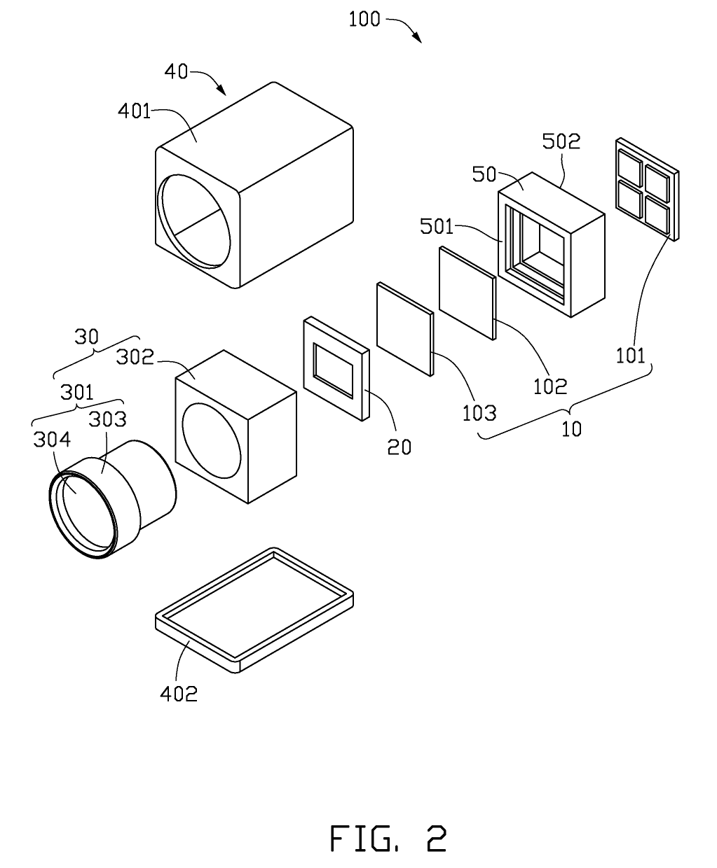

Referring to FIGS. 1 and 2, a portable transmissive type projector 100, in accordance with an exemplary embodiment, includes a light source module 10, a light pervious display panel 20, a lens module 30, and a first shell 40. The first shell 40 is configured for receiving the light source module 10, the light pervious display panel 20 and the lens module 30, in that order.

The light source module 10 includes a light source 101, a diffusion film 102, and a brightness enhancement film 103. The diffusion film 102 and the brightness enhancement film 103 are disposed along a path of light emitted from the light source 101.

The light source 101 in the exemplary embodiment includes an LED array. It is to be understood that the number of light sources 101 and the types of light source 101 can vary depending on application needs.

The diffusion film 102 is adapted for diffusing light beams emitted from the light source 101. The diffusion film 102 may be a macromolecular film containing a plurality of inorganic particles, or another suitable kind of diffusion film as would be known to those skilled in the art. When light beams emitted from the light source 101 travel through the diffusion film 102, the light beams are scattered in random directions. Thus the light emitting from the diffusion film 102 has substantially uniform intensity.

Typically, the brightness enhancement film 103 is a prism sheet. The brightness enhancement film 103 raises the efficiency of light utilization by gathering input light and concentrating the input light toward more uniform output angles. Typically, this is achieved by a fine prism configuration provided on the brightness enhancement film 103. In an alternative embodiment, the diffusion film 102 and the brightness enhancement film 103 can be integrally formed with each other as a single body. In operation, light beams emitted from the light source 101 first transmit through the diffusion film 102 and then the brightness enhancement film 103, and then reach the light pervious display panel 20.

The portable projector 100 can further include a second shell 50. The second shell 50 is generally cubic shaped, and has a first opening end 501 and an opposite second opening end 502. The light source 101, the diffusion film 102 and the brightness enhancement film 103 are engagingly received in the second shell 50. The first opening end 501 faces the light pervious display panel 20. The brightness enhancement film 103 is disposed in the first opening end 501, and the light source 101 is disposed in the second opening end 502.

The light pervious display panel 20 in the exemplary embodiment is a transmission type liquid crystal panel. In alternative embodiments, the light pervious display panel 20 can be a sheet of plastic (e.g., polyester, nitrocellulose, or cellulose acetate) coated with images.

The lens module 30 includes a lens system 301, and a holder 302 configured for receiving the lens system 301. The lens system 301 in the exemplary embodiment includes a lens barrel 303, and at least one lens 304 accommodated in the lens barrel 303. The lens system 301 directs the image on the light pervious display panel 20 to a viewing screen or similar object. Different lenses 304 can be used for different aspect ratios.

The first shell 40 includes a base 402, and a cover 401 having a window 403 defined therein. The base 402 and the cover 401 cooperatively define an accommodating room for receiving the light source module 10, the light pervious display panel 20 and the lens module 30 therein. The window 403 is adjacent to the lens module 30. In the exemplary embodiment, the window 403 is a void. In alternative embodiments, the window 403 can be a glass panel, or another suitable kind of transparent panel as would be known to those skilled in the art.

In operation of the portable projector 100, projection patterns, images, or videos etc. (not shown) that are present, generated, or shown on the light pervious display panel 20 are illuminated by the light beams emitted from the light source module 10, and then projected from the lens module 30 through the window 403 onto a projection screen and the like (not shown). Unlike conventional projectors, the portable projector 100 has a simple structure and occupies only a relatively small space. Therefore, the portable projector 100 can be carried or moved easily.

It is to be understood, however, that even though numerous characteristics and advantages of various embodiments have been set forth in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A portable projector comprising:
a light source module comprising:
a light source configured for emitting light beams,
a diffusion film configured for diffusing the light beams, and
a brightness enhancement film,
wherein the diffusion film and the brightness enhancement film are disposed along a path of the emitted light beams;
a lens module comprising at least one lens; and
a light pervious display panel disposed between the light source module and the lens module, and configured for providing one or more images for display.

2. The portable projector of claim 1, wherein the light source comprises a light emitting diode array.

3. The portable projector of claim 1, further comprising a first shell having a first opening end and an opposite second opening end, the first opening end facing the display panel, and the light source module being received in the first shell, with the brightness enhancement film being disposed in the first opening end, and the light source being disposed in the second opening end.

4. The portable projector of claim 3, further comprising a second shell which has a window defined therein, the second shell receiving the first shell, the display panel, and the lens module therein, with the lens module adjacent to the window.

5. The portable projector of claim 1, wherein the display panel comprises a transmission type liquid crystal panel.

6. The portable projector of claim 1, wherein the display panel comprises a sheet comprised of plastic.

7. The portable projector of claim 1, wherein diffusion film and the brightness enhancement film are integrally formed with each other as a single body.

8. A portable projector comprising:
a light source module configured for emitting light beams,
a projection lens module, and
a transmission type liquid crystal panel disposed between the light source module and the projection lens module, the liquid crystal panel configured for generating images, and the projection lens module configured for projecting the generated images illuminated by the light beams onto an external object for viewing.

9. The portable projector of claim 8, wherein the light source module comprises a light source, a diffusion film configured for diffusing the light beams, and a brightness enhancement film, the diffusion film and the brightness enhancement film being disposed along a path of the emitted light beams.

10. The portable projector of claim 9, wherein diffusion film and the brightness enhancement film are integrally formed with each other as a single body.

11. The portable projector of claim 9, wherein the light source comprises a light emitting diode array.

12. The portable projector of claim 9, further comprising a first shell having a first opening end and an opposite second opening end, the first opening end facing the transmission type liquid crystal panel, and the light source module being received in the first shell, with the brightness enhancement film being disposed in the first opening end, and the light source being disposed in the second opening end.

13. The portable projector of claim 12, further comprising a second shell which has a window defined therein, the second shell receiving the first shell, the transmission type liquid crystal panel, and the lens module therein, with the lens module adjacent to the window.

14. A portable projector comprising:
a housing having a window defined therein,
a light source module configured for emitting light beams,
a transmission type liquid crystal panel for displaying images, and
a projection lens module,
wherein the light source module, the transmission type liquid crystal panel, and the projection lens module are arranged in the housing in that order, with the projection lens module adjacent to the window.

15. The portable projector of claim 14, wherein the light source module comprises a light source, a diffusion film configured for diffusing the light beams, and a brightness enhancement film, the diffusion film and the brightness enhancement film being disposed along a path of the emitted light beams.

16. The portable projector of claim 15, further comprising a shell having a first opening end and an opposite second opening end, the first opening end facing the transmission type liquid crystal panel, and the light source module being received in the shell, with the brightness enhancement film being disposed in the first opening end, and the light source being disposed in the second opening end.

17. The portable projector of claim 15, wherein diffusion film and the brightness enhancement film are integrally formed with each other as a single body.

18. The portable projector of claim 14, wherein the light source comprises a light emitting array.
